(19) United States
(12) Patent Application Publication
(10) Pub. No.: US 2019/0013776 A1
(43) Pub. Date: Jan. 10, 2019

(54) Solar energy concentrator system

(71) Applicant: Raja Singh Tuli, Montreal (CA)

(72) Inventor: Raja Singh Tuli, Montreal (CA)

(21) Appl. No.: 15/645,689

(22) Filed: Jul. 10, 2017

(51) Int. Cl. H02S 40/22; H02S 20/32; H02S 40/44

(52) U.S. Cl. CPC H02S 40/22; H02S 40/44; H02S 20/32

(57) ABSTRACT

The present invention discloses a solar concentrator for supplying energy. Sunlight is redirected by a concentrating reflector toward a target area, whereat concentrated sunlight is collected and converted by a solar panel. As the target area changes position based on daily and seasonal solar movement, the position of the solar panel is adjustable to track the target area. The solar panel is guided by a repositioning mechanism, and both the repositioning mechanism and the solar panel are supported by a mechanical structure. The present invention discloses various embodiments for the repositioning mechanism and mechanical structure to enable tracking the target area two-dimensionally with minimal efficiency losses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not applicable

### BACKGROUND OF THE INVENTION

### Field of the Invention

The present invention generally relates to a solar concentrator. In particular, the present invention relates to a low-cost system that can be dimensioned to supply energy to a household. Being tracked by actuators or sensors, the rays of the sun are redirected by reflectors and collected by a solar panel. The solar light collected by the solar panel is converted into electrical power, which can be used for heating or for supplying electricity to a building or adjacent real estate unit. In the case of relatively small real estate, a self-supplying household may be taken off the electrical supply grid, contributing both to the household finances and to environmental conservation.

### Description of the Related Art

With the worldwide population growing steadily, demand for energy scales up. This intensifying demand takes place in a time when traditional sources of energy face particular pressure due to the scarcity of resources as well as stronger calls by customers and households for energy sources that minimize the negative environmental impact. To cope with this conundrum, solar energy constitutes an attractive and reliable alternative based on a readily available energy source—solar light. In this context, there is a need for a better use of solar energy, more specifically for means that provide a more efficient concentration of solar radiation and its conversion at low costs. In addition, by dispensing with distribution costs, means for local concentration and conversion of solar energy reduce overall costs and make solar power more affordable for households and other small units of real estate owners.

Over the years, solar energy research has helped develop systems that have improved efficiency and are more economical. However, a dearth of information, materials, complexity, and manufacturing skills remain an impediment to large-scale production and utilization of this abundantly available energy source for household supply. Due to lack of economic incentives and technical means, access to this technology is particularly difficult in some rural regions of developing countries. One way of overcoming obstacles related to lack of technical knowledge involves reducing the number of complex manipulations or maintenance operations by users.

The typical solar concentrators can be classified according to several aspects. The ones relevant for the purpose of the present description are the kind of focusing employed (point, line or area), positional adjustability of the reflectors involved in the concentration process (fixed or tracking devices) and characteristics of the conversion systems—solar panels, heat absorbers, or both.

Compared to non-concentrating solar energy conversion systems, the sunlight concentrated toward a photovoltaic solar panel is magnified. As a result, on the one hand, solar energy concentrator systems benefit more than non-concentrating solar energy systems from using relatively more performing solar panels. Efficiency improvements are fast in the field of photovoltaic solar cells, and solar energy concentrator systems thus benefit particularly from an easy upgrade to a more efficient solar panel. On the other hand, more heat is gathered at the target area of a concentrator system than in a non-concentrating solar energy system. Heat negatively affects the efficiency of photovoltaic solar panels, entailing that efficient heat transfer or cooling systems have a special importance in solar energy concentrator systems that rely on photovoltaic solar panels as their receivers.

Several examples of solar energy concentrators are found in the prior art. These apparatuses feature several inconveniences, such as complexity and cost. Furthermore, many of those designs do not easily lend themselves to installation in the scale contemplated for supplying a household. For example, the structural weight and design of even a small-sized, movable dish reflector complicates its deployment atop a house roof, in addition to making it vulnerable to wind damage. Sidestepping these problems by reducing the scale of the dish reflector seriously limits the amount of energy this kind of concentrator may yield.

Based on the end application, different types of solar concentrators are employed to achieve optimum results. In the specific scope of the present invention—continual collection of concentrated solar radiation reflected to a focal area in order to generate energy for supplying a standard household or small real estate unit—the performance of state of the art solar concentrators is suboptimal, or the system is too expensive or complex for use by a standard household or in a small real estate unit.

Line focus systems of solar energy concentration, as in U.S. Pat. No. 5,374,317 (Lamb et al.) or U.S. Pat. No. 4,065,053 (Fletcher), typically perform less in concentrating solar radiation than area or point focus. Moreover, line focus systems tend to be bulky. The size and shape of these bulky systems entail higher manufacturing costs (for materials) and require a larger area for their installation. These characteristics make line focus systems rather inadequate for implementation for a standard household or small real estate unit. Conversely, point focus, as in U.S. Patent Publication No. US20110088684 A1 (Tuli) and others, typically requires multiple sets of concentrating reflectors. A substantially high degree of precision is thus required, both in terms of mechanical adjustments of the reflectors and in terms of data analysis and predictions.

For instance, as in U.S. Pat. No. 6,530,369 (Yogev et al.), concentrators comprising a central receiver tower are typically employed in large scale applications for electricity generation. These embodiments require vast real-estate for proper deployment and are thus not economical or convenient for small- and medium-scale applications. Parabolic dish concentrators with continuous surfaces, as in U.S. Pat. No. 7,435,898 (Shifman), entail limitations such as the prohibitive manufacturing costs associated with compound and complex reflector curves as well as expensive mirror substrates.

Most prior art applications of solar energy concentrators involve a primary concentrating reflector that is movable, as can be found in U.S. Pat. No. 8,471,187 (Kinley). In addition to cost issues and physical vulnerabilities inherent to a movable primary concentrating reflector, the moving components need to each be associated with a tracking system and a moving mechanism for the moving feature to improve the system's performance. When integrated to the primary concentrating reflector, these requirements and the associated costs and vulnerabilities are multiplied because primary concentrating reflectors are typically made of numerous parts.

In U.S. Patent Publication No. US20110088684 A1 (Tuli) by the same inventor, a solar energy concentrator is disclosed whereby rays of the sun are reflected and concentrated to a heat absorber by a combination of a fixed primary concentrating reflector and a movable secondary redirecting reflector. The secondary redirecting reflector is ball-pivotally connected to an elongated arm that is itself ball-pivotally connected to a stationary surface. Alternatively, there is no secondary redirecting reflector, and the heat absorber is connected at the distal end of the elongated arm. Unlike in the present invention, this system uses a heat absorber instead of a solar panel. The solar energy concentrator disclosed therein includes several physical components that potentially block the solar radiation reflected by the primary concentrating reflector before it can be collected by the receiver. Moreover, the supporting components are in itself vulnerable to wear and tear, wind and other weather conditions, thus necessitating a suboptimal retraction of the elongated arm to prevent damages to the structural integrity of the elongated arm when wind conditions are threatening. The elongated arm can also be vulnerable when the position of the sun requires the elongated arm to be sharply inclined in order to receive solar radiation redirected by the primary concentrating reflector.

There is accordingly a need for an improved solar concentrating system that overcomes the limitations associated with using complex or suboptimal structures or assemblies that require a high degree of skills. Moreover, there is a need for an improved solar concentrating system wherein the costs associated with manufacture and deployment, which are prohibitive with respect to traditional solar concentrating systems, are minimized so that it is affordable and attractive for use by small- and medium-scale household use.

It is therefore an object of the present invention to disclose a small- or medium-scale, dimensionally-adaptable solar concentrator system featuring high energy conversion efficiency, providing area focus with low building and operational costs.

### BRIEF SUMMARY OF THE INVENTION

According to a certain aspect of the present invention, there is disclosed a solar energy concentrator comprising a concentrating reflector, a solar panel, a repositioning mechanism that guides the positioning of the solar panel and a mechanical structure that supports the repositioning mechanism and solar panel. The concentrating reflector is made of multiple reflecting surfaces that are stationary with respect to earth and laid over a two-dimensional flat plane surface, all of said multiple reflecting surfaces cooperating to redirect the incident solar radiation toward a small target area. Since the reflecting surfaces are stationary, the target area continually changes position based on daily and seasonal solar movement. Supported by the apparatus' mechanical structure and guided by the repositioning mechanism, the solar panel is continually positioned near the target area to receive the light redirected by the concentrating reflector, thereby collecting concentrated solar radiation and converting it into electricity.

The repositioning mechanism mainly consists of a lateral arm, to which the solar panel is attached. The solar panel is installed and connected to the lateral arm in a way that allows its rotation. A system of belts and pulleys inside the lateral arm, or a similar mechanism as can be known in the art, can be activated to move the solar panel along the lateral arm. The range of this movement depends on the particular mechanical structure used to support the repositioning mechanism.

In an exemplary embodiment, the mechanical structure consists of a single vertical arm, preferably embedded at the center of the plane surface of the concentrating reflector. The lateral arm is connected to the vertical arm, near the top of the vertical arm. The solar panel is attached to one side of the lateral arm, and a counterweight can be placed on the other side of the lateral arm to keep the lateral arm perpendicular to the vertical arm. The lateral arm is built and installed in a way that allows its rotation around the vertical arm. The solar panel can be moved along the lateral arm in a range that extends from the middle of the lateral arm to the end of the lateral arm that is opposite to the counterweight, if a counterweight is installed. A slot can be cut in the solar panel so that the solar panel slides around the exterior surface of the vertical arm and reaches the middle of the lateral arm to receive solar radiation redirected near the vertical arm. With the rotation of the lateral arm and the movements of the solar panel along the lateral arm, the repositioning mechanism is capable of continually maintaining the solar panel as close as possible to the target area by tracking the locations of the target area while moving the solar panel two-dimensionally.

In a first alternate embodiment, the mechanical structure consists of a single vertical arm similar to the exemplary embodiment preferably embedded at the center of the plane surface of the concentrating reflector. However, a portion of the vertical arm is divided into two side branches forming a squared jaw. The lateral arm is connected to the vertical arm, near the top of the vertical arm. The solar panel is attached to one side of the lateral arm, and a counterweight can be placed on the other side of the lateral arm to keep the lateral arm perpendicular to the vertical arm. The lateral arm is built and installed in a way that allows its rotation around the vertical arm. The solar panel can be moved along the lateral arm in a range that extends from the middle of the lateral arm to the end of the lateral arm that is opposite to the counterweight, if a counterweight is installed. To reach the middle of the lateral arm and receive solar radiation redirected near the vertical arm, the solar panel is simply moved through the gap formed by the side branches. With the rotation of the lateral arm and the movements of the solar panel along the lateral arm, the repositioning mechanism is capable of continually maintaining the solar panel as close as possible to the target area by tracking the locations of the target area while moving the solar panel two-dimensionally.

In a second alternate embodiment, the mechanical structure consists of at least two vertical side beams and one horizontal top beam. When there are only two, the side beams are preferably erected at two opposite corners of the stationary plane of the concentrating reflector. The two side beams support both ends of the top beam, which passes through, or close to, the center vertical axis of the concentrating reflector. Positioned below the top beam, the lateral arm is linked to the middle, or close to the middle, of the top beam by a connecting arm. The solar panel is attached to one side of the lateral arm, and a counterweight can be placed on the other side of the lateral arm to keep the lateral arm perpendicular to the side beams. The lateral arm is built and installed in a way that allows its rotation around the connecting arm. The solar panel can be moved along the lateral arm in a range that extends from the middle of the lateral arm to the end of the lateral arm that is opposite to the counterweight, if a counterweight is installed. With the rotation of the lateral arm and the movements of the solar panel along the lateral arm, the repositioning mechanism is capable of continually maintaining the solar panel as close as possible to the target area by tracking the locations of the target area while moving the solar panel two-dimensionally.

In a third alternate embodiment, a prism structure is erected on the stationary plane of the concentrating reflector. The prism structure is constituted of at least four vertical prism beams. Lateral prism beams connect the vertical prism beams together, preferably at their top ends. The lateral arm is connected to any two lateral prism beams facing each other, and a motorized system inside the two lateral prism beams that are connected to the lateral arm allows the lateral arm to be moved along the entire lengths of those two lateral prism beams. The solar panel is attached to the lateral arm, and it can be moved along the entire length of the lateral arm. With the movements of the lateral arm along the two lateral prism beams to which it is connected and the movements of the solar panel along the lateral arm, the mechanical structure and the repositioning mechanism are capable of continually maintaining the solar panel as close as possible to the target area by tracking the locations of the target area while moving the solar panel two-dimensionally.

To receive solar radiation in a more perpendicular angle, the solar panel can be tilted, and its surface can be mechanically or electronically adjusted to become flat, curved in a concave shape or curved in a convex shape. In addition to those adjustments, the lateral arm can be slightly curved to allow the solar panel to receive solar radiation in a more perpendicular angle. A mirror reflector can be fastened against the solar panel in order to divert toward the solar panel some of the solar radiation, if any, that is redirected from the concentrating reflector and whose trajectory does not meet the space covered by the solar panel. In a preferred embodiment, the solar panel is oval in shape. When in operation, the invention's various mechanisms can be mechanically or electronically controlled by a digital control system, which can be connected to optical sensors. The digital control system can collect feedback data from the sensors and adjust optimally the invention's various mechanisms based on the collected data.

According to an additional embodiment, the solar panel is covered with a filter, such as an optical filter, that does not prevent the passage of parts of solar radiation that can be absorbed by the solar panel, yet reflects parts of solar radiation that would not be absorbed by the solar panel. Relying on the tilting mechanism of the solar panel, on the curvature of the solar panel, or both, the filter reflects this unabsorbed solar radiation toward a central heat absorber positioned on the plane surface of the concentrating reflector, preferably at its center. The central heat absorber in turn collects the heat of the infrared solar radiation diverted upon it, thereby increasing its temperature. The central heat absorber uses this heat as a source of energy, for instance to generate electricity or directly transfer this heat to a useful purpose such as heating water or heating the building on which the solar energy concentrator is installed.

According to an additional embodiment, excessive heat at the solar panel is removed using a heat transfer fluid pipe. A heat pipe is encased into the solar panel, and this heat pipe extends into other components of the solar energy concentrator system, such as the repositioning mechanism, mechanical structure or the concentrating reflector. In the portion of the heat pipe encased in the solar panel, the heat pipe contains a working fluid that lies in a liquid phase under normal ambient temperatures, but transforms into a vaporous phase when in the range of temperatures that the solar panel reaches during operation of the present invention. When heat is gathered at the surface of the solar panel, the materials of the solar panel conduct this heat to the section of the heat pipe that is encased therein. As the temperature increases in the section of the heat pipe encased in the solar panel, the working fluid contained therein is heated, and it eventually transforms into a vaporous phase, its volume thus expanding. This expansion causes pressure into the heat pipe, which results in the vapor being pulled out of the section of the heat pipe that is encased in the solar panel, toward sections of the heat pipe encased in other components of the solar energy concentrator system. In these other sections of the heat pipe, heat is conducted to the colder solid materials of their corresponding components. The consequent temperature drop in those sections of the heat pipe causes the working fluid to transform back into a liquid phase, and the resulting working fluid in a liquid phase is eventually drawn back to the section of the heat pipe encased in the solar panel.

The present invention provides numerous advantages over other solar energy concentrators systems known in the art. Area focusing allows a high solar concentration and small losses attributable to the required size of a solar panel.

The above as well as additional features and advantages of the present invention will become apparent in the following written detailed description.

### BRIEF DESCRIPTION OF THE SEVERAL VIEWS OF THE DRAWINGS

The invention is described in more detail below with respect to an illustrative embodiment shown in the accompanying drawings in which:

FIG. 1 is a drawing illustrating a sectional view of the exemplary embodiment of the present invention.

FIG. 2 is a drawing illustrating a plan view of the exemplary embodiment of the present invention.

FIG. 3 is a drawing illustrating a sectional view of the exemplary embodiment of the present invention wherein the facets of the concentrating reflector are flat.

FIG. 4 is a drawing illustrating a plan view of the exemplary embodiment of the present invention wherein the facets of the concentrating reflector are flat.

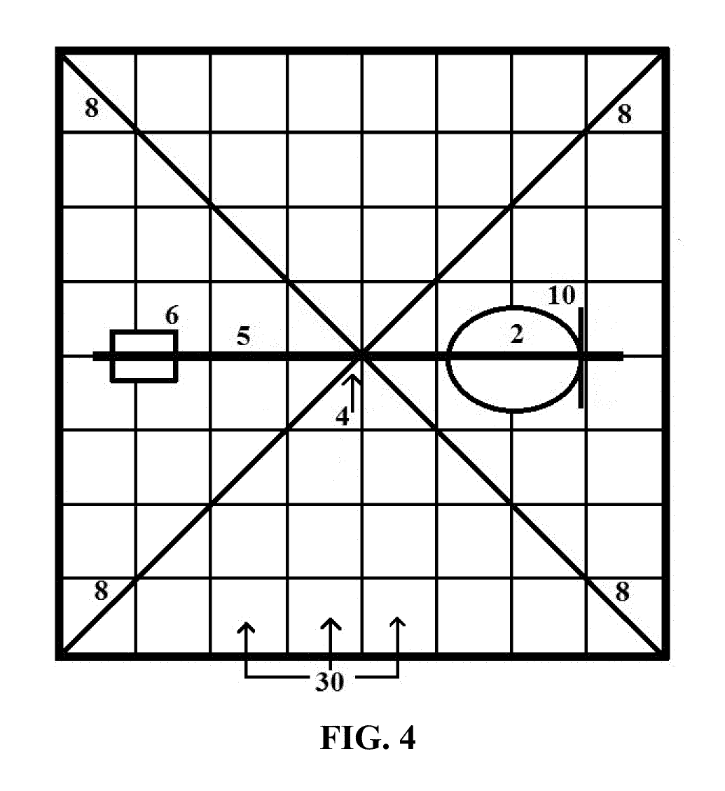

FIG. 5 is a drawing illustrating a side view of different embodiments of the curvature of the solar panel in the present invention.

FIG. 6 is a drawing illustrating a sectional view of the exemplary embodiment of the present invention wherein part of the sunlight reflected by the concentrating reflector is redirected toward the solar panel by a mirror reflector connected to the solar panel.

FIG. 7a is a drawing illustrating a sectional view of the exemplary embodiment of the present invention when the solar panel is straight.

FIG. 7b is a drawing illustrating a sectional view of the exemplary embodiment of the present invention when the solar panel is tilted.

FIG. 8a is a drawing illustrating a sectional view of the exemplary embodiment of the present invention wherein the curvature of the solar panel is convex.

FIG. 8b is a drawing illustrating a sectional view of the exemplary embodiment of the present invention wherein the curvature of the solar panel is concave.

FIG. 9 is a drawing illustrating a sectional view of the exemplary embodiment of the present invention showing the inefficiency of a solar panel that has no slot cut in.

FIG. 10 is a drawing illustrating a plan view of the present invention's solar panel in the exemplary embodiment with a slot cut in.

FIG. 11 is a drawing illustrating a sectional view of the exemplary embodiment of the present invention using a solar panel that has a slot cut in.

FIG. 12 is a drawing illustrating a sectional view from a side perspective of the first alternate embodiment of the present invention wherein the vertical arm is divided into branches.

FIG. 13 is a drawing illustrating a sectional view from a frontal perspective of the first alternate embodiment of the present invention wherein the vertical arm is divided into branches.

FIG. 14 is a drawing illustrating a sectional view of the second alternate embodiment of the present invention with a side structure.

FIG. 15 is a drawing illustrating a plan view of the second alternate embodiment of the present invention with a side structure.

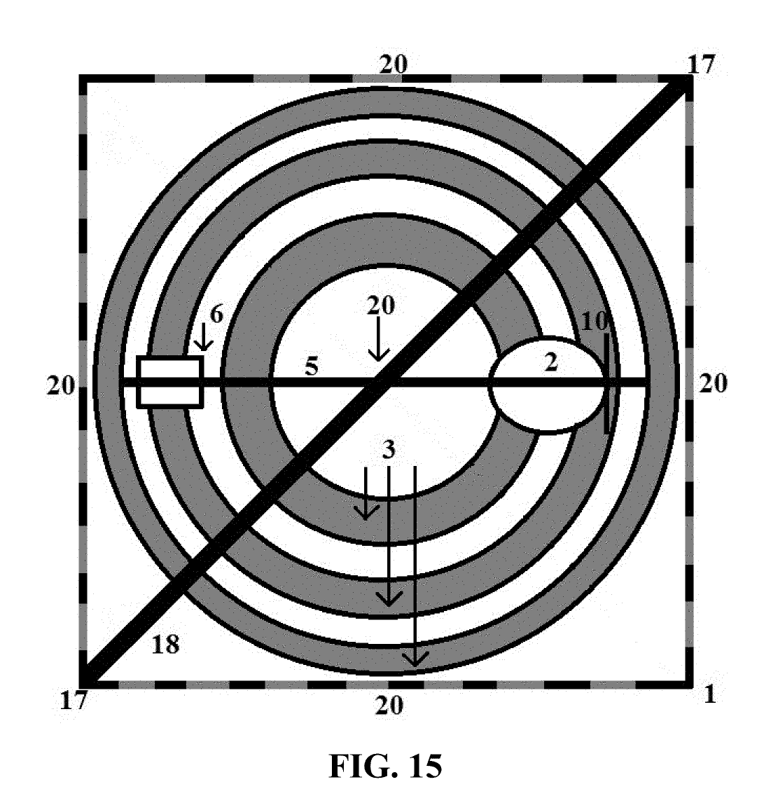

FIG. 16 is a drawing illustrating a perspective view of the third alternate embodiment of the present invention with a prism structure.

FIG. 17 is a drawing illustrating a perspective view of the third alternate embodiment of the present invention with a prism structure, in which the lateral arm extends beyond the prism structure.

FIG. 18 is a drawing illustrating a sectional view of an additional embodiment of the present invention, wherein part of the sunlight is filtered out of the solar panel and redirected toward a heat absorber.

FIG. 19 is a drawing illustrating a sectional view of the solar panel with a heat pipe, as disclosed in an additional embodiment of the present invention.

Where used in the various figures of the drawings, the same numerals designate the same or similar parts.

### DETAILED DESCRIPTION OF THE INVENTION

Main Components

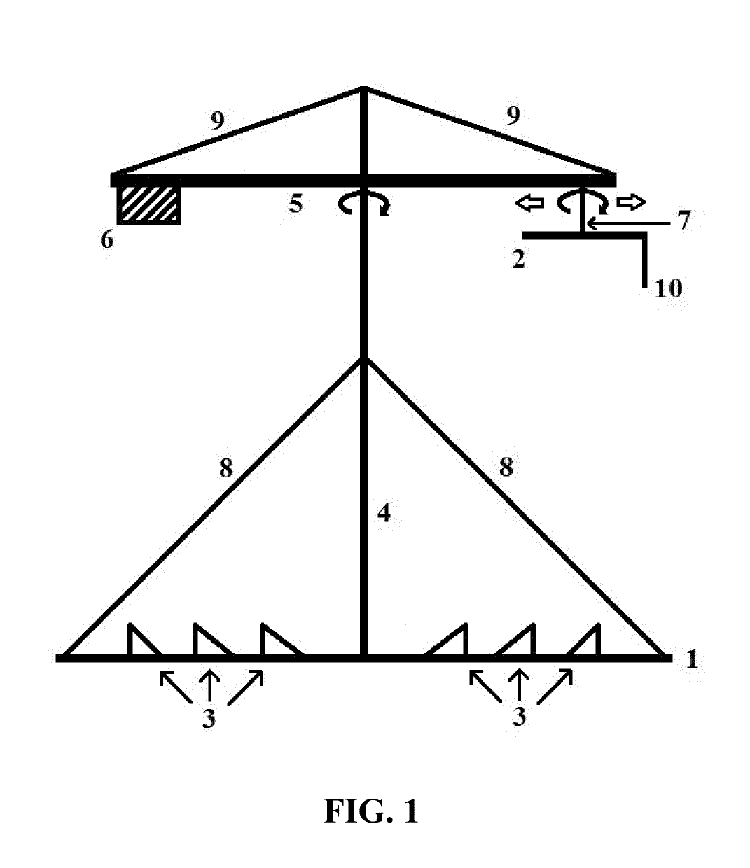

The solar concentrator disclosed in the principal embodiments of this invention (FIGS. 1 & 2) comprises a concentrating reflector 1, a solar panel 2 and a mechanical structure elevated on the concentrating reflector 1, which structure supports a lateral arm 5 that guides the positioning of the solar panel 2.

### Concentrating Reflector

The concentrating reflector 1 is made of an array of reflecting surfaces 3 laid over a two-dimensional, stationary plane surface on which they are themselves stationary. The reflecting surfaces 3 are made of glass, blow-molded plastic or other transparent material, coated with a reflective layer. Alternatively, they can be made of a structurally sound material that is naturally reflective, such as aluminum, stainless steel or a chrome-plated metal.

Reflecting surfaces 3 can be either curved or flat. The concentrated light redirected off flat reflecting surfaces is more homogenous than the concentrated light redirected off curved reflecting surfaces. Depending on the type of solar panel 2 used, homogeneity of the redirected light can be a characteristic affecting the optimal collection and conversion of solar energy. If the solar panel 2 used is more efficient when it receives relatively more homogenous light, flat reflecting surfaces 3 should be preferred.

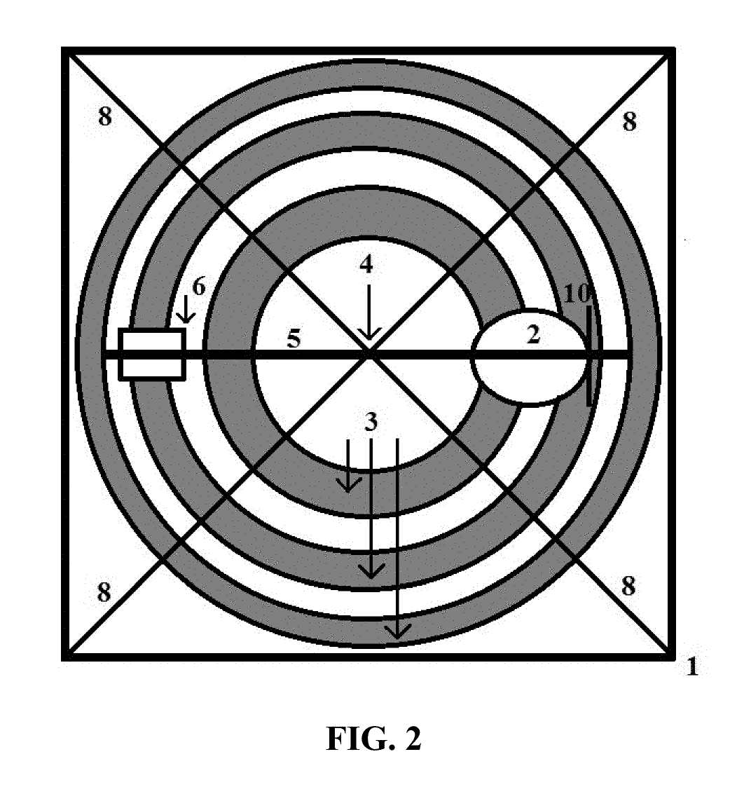

Whether curved or flat, the reflecting surfaces 3 can be discrete rectangular facets or, as in the principal embodiments illustrated herein, continuous ring facets (see 3 in FIG. 2). Ring facets may be segmented in order to facilitate assembly on the surface whereon this invention's solar concentrator is installed, such as the roof of a house or of another type of building, the ground, and so forth.

When solar rays impinge on the reflecting surfaces 3, each of them redirects the light toward one common small target area, just like in a Fresnel lens, thus focusing solar radiation at this focal area. To achieve this effect as efficiently as possible, each of these multiple reflecting surfaces 3 can have its shape and position optimized in a way that maximizes the amount of incident solar radiation redirected toward the small target area. Typically, the reflecting surfaces 3 whose shapes are determined by these optimizing calculations are slightly curved and concave. Since the reflecting surfaces 3 are stationary, this target area continually changes position based on daily and seasonal solar movement. These position changes occur tri-dimensionally. The optimizing calculations made to initially determine the positions of the reflecting surfaces 3 on the concentrating reflector 1, as well as their shapes, can take these movements into account in various ways, for instance, by ensuring that the target area continuously remains at a height and range that are manageable by this invention's structure and solar panel 2; by maximizing the daily average of solar radiation collection on an annual basis; by maximizing the average of solar radiation collection during peak hours of the day; or any other preferred embodiment to establish with this invention a desired output or efficiency level of solar energy concentration or conversion.

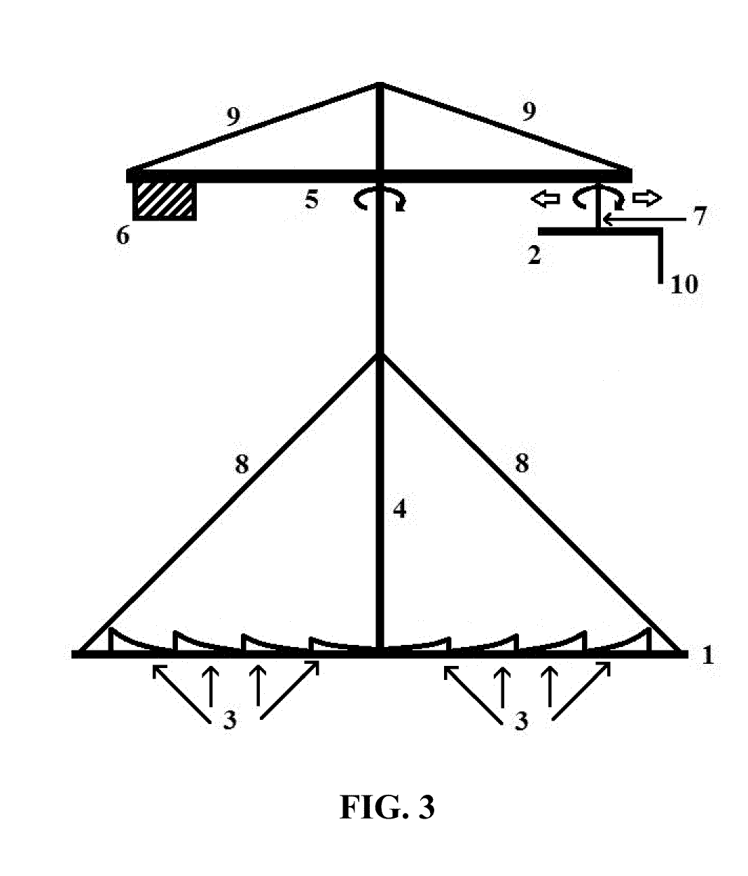

In alternative embodiments for the concentrating reflector 1, illustrated in FIGS. 3 & 4, reflecting surfaces 3 are made of rectangular (preferably square) facets 30 that are each slightly curved toward the center of the concentrating reflector 1. As in the principal embodiments, each of these facets 30 can have its shape optimized in a way that maximizes the amount of incident solar radiation redirected toward the small target area. In that event, the particular curvatures of these facets 30 allow them to collaborate to optimally concentrate the incident light onto a small target area. Alternatively, the facets 30 can be flat, in order to redirect relatively more homogenous concentrated light toward the solar panel 2. Even in this alternative modular embodiment, as can be seen in the cross-sectional view of FIG. 3, the juxtaposed facets 30 together form reflecting surfaces 3 that are substantially annular. Although the principal embodiments of the present invention are drawn with respect to a concentrating reflector 1 with reflecting surfaces 3 that are continuous ring facets, a person skilled in the art would recognize that these embodiments can integrate a concentrating reflector 1 whose reflecting surfaces 3 are instead constituted by rectangular (preferably square) mirror facets 30.

### Solar Panel

Through this invention's mechanical or electronic operations, the position of the solar panel 2 is maintained as near as possible to the target area of the concentrated radiation continually redirected by the concentrating reflector 1, thereby collecting concentrated solar radiation and converting it into heat or electricity. The solar panel 2 has a certain shape, typically square or rectangular when based on prior art apparatuses. In a preferred embodiment of this invention, which can be seen on FIG. 2, the solar panel 2 is rather oval in shape. This preferred shape for the solar panel 2 is the result of the annular outline of the reflecting surfaces 3. On the one hand, the beam of light reflected from each reflecting surface 3 is round by construction. On the other hand, rays of the sun hit the reflecting surfaces 3 with an angle, entailing that the reflected, round beams are stretched in at least one direction in comparison with a circle. If the size of an oval-shaped solar panel 2 is appropriately determined with the parameters of its corresponding concentrating reflector 1, it is capable of fully receiving the solar radiation redirected toward it by the concentrating reflector 1. Unlike a square or rectangular solar panel whose size would be appropriately determined in this way, an oval-shaped solar panel requires less material and is thus more efficient. The relatively smaller area covered by an oval-shaped solar panel 2 also provides the incidental benefit of blocking less solar radiation incoming from the sun toward the concentrating reflector 1.

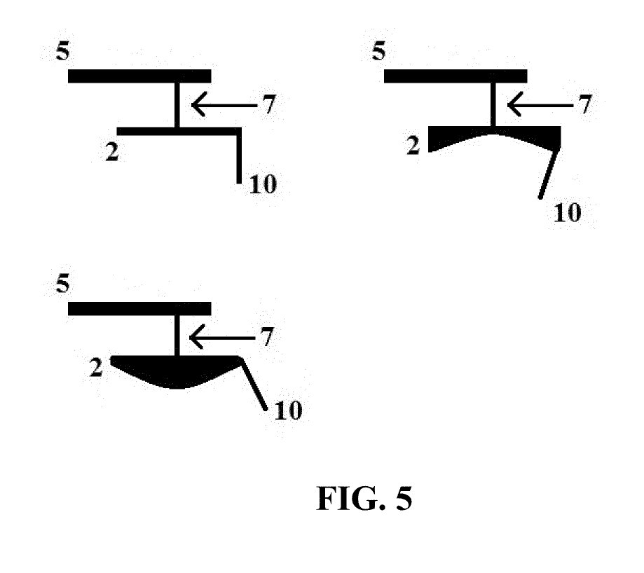

As can be seen in FIG. 5, the surface of the solar panel 2 can be flat, concave, or convex. In one embodiment, this curvature of the solar panel 2 can be mechanically or electronically adjusted during operation of this invention's solar concentrator.

### Mechanical Structure and Lateral Arm

As explained in more details below, the structure that supports the solar panel 2 in this invention is mechanically or electronically activated by a digital control system (not shown), so that the solar panel 2 keeps being continuously positioned as close as possible to the target area. In an exemplary embodiment, this structure is predominantly supported by a vertical arm 4, such as a pole, that is preferably embedded at the center of the plane surface of the concentrating reflector 1 (as can be seen in FIG. 2). A lateral arm 5 such as a beam, whose main purpose is to support the solar panel 2, is connected to the vertical arm 4, near the top of the vertical arm 4. The height of the vertical arm 4 and the position of the lateral arm 5 in relation with the vertical arm 4 are determined by the height level required in order for the solar panel 2 to continuously remain as near as possible to the position of the small target area of solar radiation redirected by the concentrating reflector 1. To this end, the lateral arm 5 can be linearly straight, or it can be slightly curved upward or downward. Although the various embodiments of the present invention are drawn with respect to a linearly straight lateral arm 5, a person skilled in the art would recognize that these embodiments can readily be adapted to implement a slightly curved lateral arm 5.

In the exemplary embodiment, the solar panel 2 always remains on a specific side of the lateral arm 5. If the structure that supports the solar panel 2 is not sturdy enough for the lateral arm 5 to remain straight—perpendicular to the vertical arm 4—during operation and movements of the solar panel 2, a counterweight 6 can be placed on the other side of the lateral arm 5 to help maintain the lateral arm 5 straight. In a particular embodiment, the counterweight 6 can be slided or moved along its side of the lateral arm 5 to help maintain the lateral arm 5 straight. The weight, size and shape of the counterweight 6 are chosen so that the counterweight 6 does not interfere with movements of the solar panel 2. The solar panel 2 can be attached to the lateral arm 5 in various ways, for instance, in a preferred embodiment, with a connecting bar 7.

In the exemplary embodiment, lower support cables 8 attach the vertical arm 4 is approximately at its mid-height to the sides of the stationary plane of the concentrating reflector 1. This design enhances the stability of the vertical arm 4 and prevents it from bending or toppling over. This precaution is important because of wind and other weather conditions, and, to the same effect, supplementary or alternative stability measures known in the art could be integrated to this invention's structure. In addition to the lower support cables 8, two higher support cables 9, preferably attaching each end-side of the lateral arm 5 to the top of the vertical arm 4, contribute in maintaining the lateral arm 5 in its position and sustain part of the weight of the solar panel 2 (and the counterweight 6, if the latter is implemented). With the reinforcement provided by the higher support cables 9, the lateral arm 5 that is integrated to the structure of the exemplary embodiment does not need to be particularly strong.

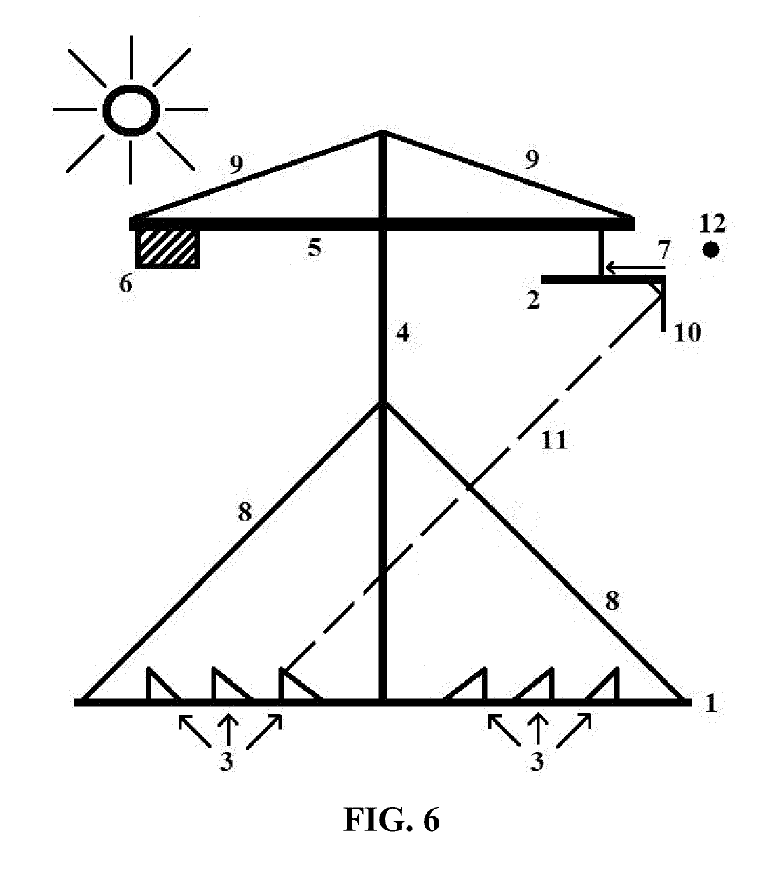

In a preferred embodiment of this invention, a mirror reflector 10 is fastened against the solar panel 2, potentially diverting toward the solar panel 2 some of the solar radiation, if any, that is redirected by the concentrating reflector 1 and whose trajectory does not meet the space covered by the solar panel 2. The mirror reflector 10 can be square, rectangular, circular, oval or have any other shape that does not prevent it from effectively diverting redirected solar radiation toward the solar panel 2. FIG. 6 shows a case in which a solar ray 11 redirected by the concentrating reflector toward a target area 12 would not have hit on the solar panel 2 if the latter had stood by itself. In this case, this solar ray 11 is instead stopped by the mirror reflector 10, which in turn successfully diverts the redirected solar ray toward the solar panel 2. Since the mirror reflector 10 is fastened to the solar panel 2, its angle relative to the edge of the solar panel 2 is fixed. However as illustrated in FIG. 5, the angle of the mirror reflector 10 relative to the concentrating reflector 1 and this invention's structure as a whole depends on the curvature of the surface of the solar panel 2. The curvature of the surface of the mirror reflector 10 can also be flat, concave or convex. In one embodiment, this curvature can be mechanically or electronically adjusted during operation of the solar concentrator, for instance, by the digital control system more amply described below.

### Exemplary Embodiment—Basic Operations

In order for the solar panel 2 to continuously remain as near as possible from the position of the target area despite daily and seasonal solar movements, the lateral arm 5 and the solar panel 2 are built and installed in ways that allow rotation around their respective axes. The lateral arm 5 rotates around the point that connects it to the structure—in the exemplary embodiment, the lateral arm 5 thus rotates around the vertical arm 4 (see FIG. 1). The solar panel 2 rotates at or around the connecting bar 7 (or whichever apparatus or fastener that links the solar panel 2 to the lateral arm 5). The rotations of the lateral arm 5 and the solar panel 2 can be controlled by a digital control system, as more fully described below.

In a preferred embodiment, a motorized system of belts and pulleys inside the lateral arm 5 moves the connecting bar 7 (or whichever apparatus or fastener that links the solar panel 2 to the lateral arm 5) along the lateral arm 5 (see FIG. 1). The solar panel 2 moves along with the connecting bar 7 (or whichever apparatus or fastener that links the solar panel 2 to the lateral arm 5). In the exemplary embodiment, the range of this movement extends approximately from the middle of the lateral arm 5 to the end of the lateral arm 5 that is opposite to the counterweight 6, if there is a counterweight. Similar to the other mechanical components of the present invention, this motor can be activated by a digital control system. A person skilled in the art would recognize that other known methods exist to move the solar panel 2 along the lateral arm 5 in this way, and this preferred embodiment is not intended to limit the description of the present invention.

In the exemplary embodiment, the rotation of the lateral arm 5 and the movements of the connecting bar 7 (or whichever apparatus or fastener that links the solar panel 2 to the lateral arm 5) along the lateral arm 5 allow the structure and the lateral arm 5 to move the solar panel 2 anywhere in the horizontal, circular area defined by the rotation of the lateral arm 5, whose radius is thus equal to half the length of the lateral arm 5. This way, the solar panel 2 can be moved two-dimensionally so that it is continually positioned at or near the target area of concentrated solar radiation redirected by the concentrating reflector 1. By rotating the solar panel 2, the invention's structure further adjusts the orientation of the mirror reflector 10 in order to not block solar radiation incoming from the sun or redirected by the concentrating reflector 1. Moreover, the rotation of the solar panel 2, particularly when it is oval in shape, allows for better receiving the concentrated solar radiation redirected by the concentrating reflector 1.

When redirected solar rays hit the surface of the solar panel 2 perpendicularly, or relatively closer to a right angle, the solar panel 2 collects more solar radiation than if solar rays impinge with a shallow or relatively shallower angle. One of the means, already mentioned, to facilitate the likelihood of this impinging angle is by having the lateral arm 5 slightly curved upward or downward toward its ends. As a result of this slight curvature, the stationary angle by which redirected solar radiation is received by the solar panel 2 is different, and potentially closer to perpendicularity.

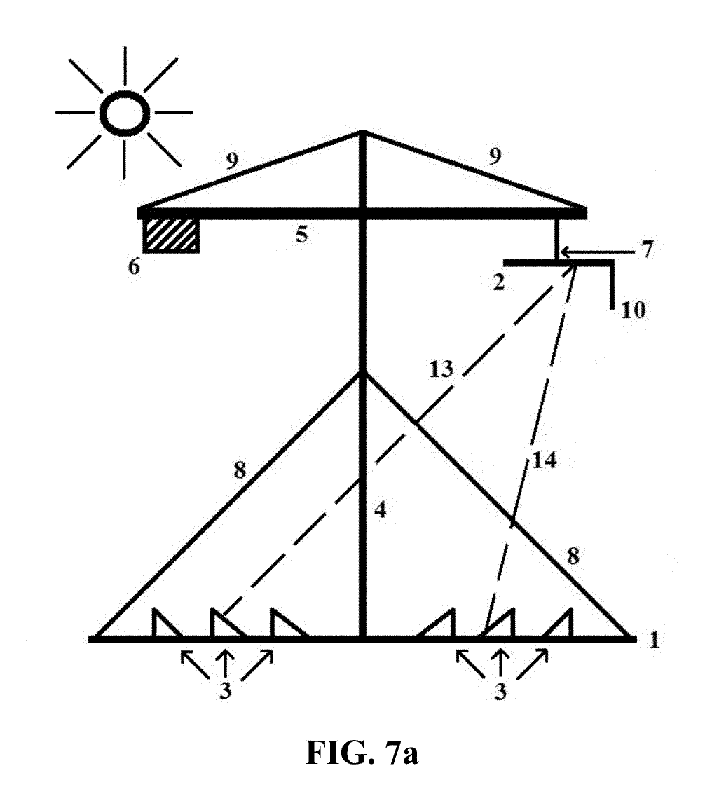

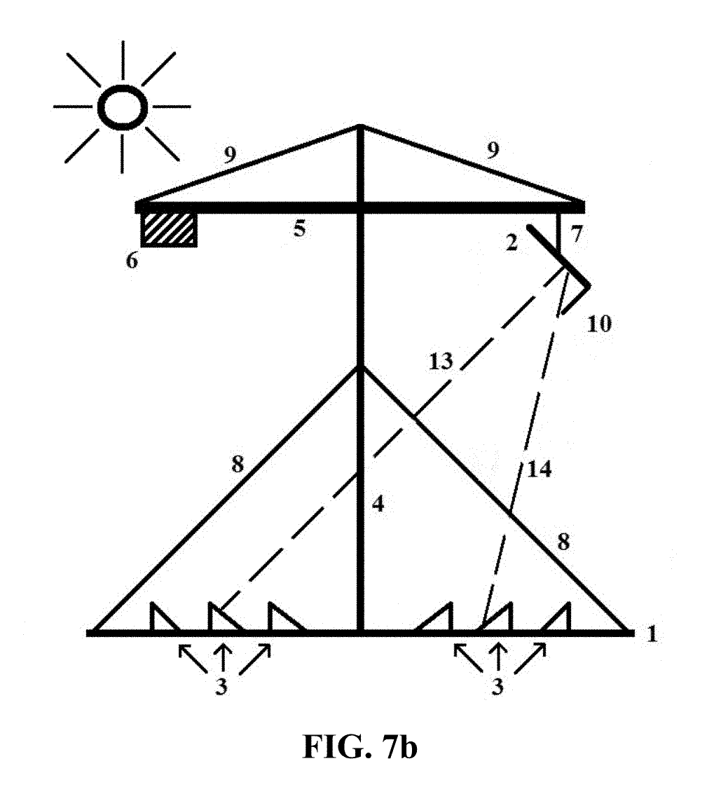

In this invention's preferred embodiment, two particular mechanisms improve the amount of solar radiation collected by the solar panel 2 by making it more likely to receive redirected solar radiation perpendicularly. First, a tilting mechanism is implemented at the connecting bar 7 (or whichever apparatus or fastener that links the solar panel 2 to the lateral arm 5), which mechanism tilts the solar panel 2 in comparison with a default position whereby the solar panel 2 is parallel to the lateral arm 5. Alternately, this tilting mechanism can be implemented either at the lateral arm 5 or at the solar panel 2 itself. In one embodiment of the tilting mechanism, the solar panel 2 is fixedly tilted to a particular angle. This angle is determined optimally, based on the structural parameters of the corresponding concentrating reflector 1 and on the sun position calculations for the particular location of the concentrating reflector 1. In another embodiment of the tilting mechanism, a variable tilt angle is implemented, and this variable tilt angle can be controlled by the invention's digital control system or by other means. As illustrated in FIGS. 7a & 7b, where the solar panel 2 is respectively straight and tilted, tilting the solar panel 2 allows the solar rays 13 redirected by the concentrating reflector 1 to hit the solar panel 2 with an angle that is significantly closer to perpendicularity. However, since redirected rays simultaneously come from every point on the reflecting surfaces 3 of the concentrating reflector 1, tilting the solar panel 2 so that solar rays 13 hit the surface of the solar panel 2 more perpendicularly is also likely to cause some other solar rays, such as solar ray 14, to hit the solar panel 2 with a less perpendicular angle. Tilting the solar panel 2 is thus more likely to increase efficiency when the curvature of the surface of the solar panel 2 is adaptable, based on the positioning of the solar panel with respect to the multiple hitting angles of solar radiation redirected by the concentrating reflector 1. As described below, this feature is integrated in the solar panel 2 of this invention's preferred embodiment.

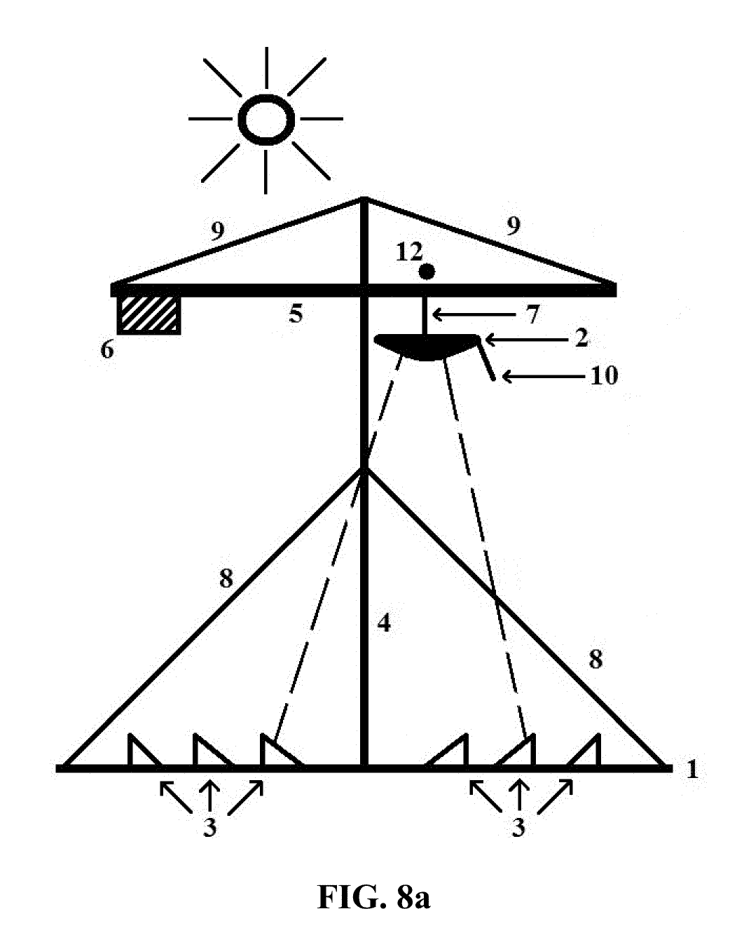

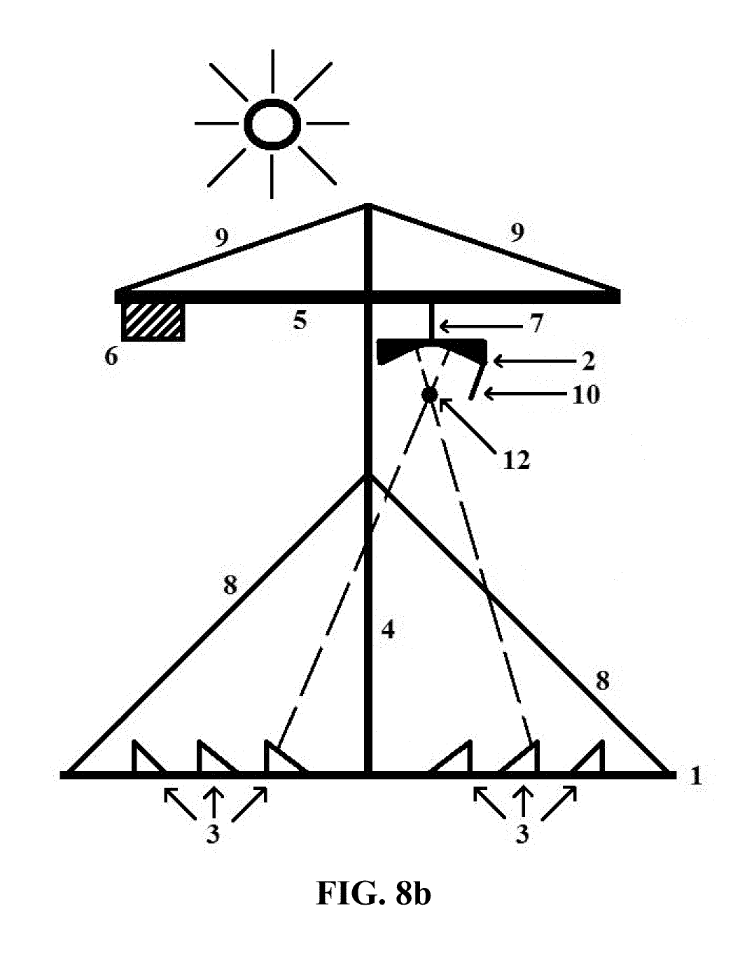

FIGS. 8a & 8b illustrate the solar panel 2 receiving solar radiation redirected by the concentrating reflector 1 toward a specific target area 12, whose coordinates are determined by the position of the sun in the sky and the shapes and positions of the reflecting surfaces 3 in the concentrating reflector 1. As shown in FIG. 8a, when the focus 12 of the target area is above the height of the solar panel 2, curving the surface of the solar panel 2 into a convex surface is more likely to cause redirected solar rays to hit it perpendicularly or closer to a right angle. Conversely, as shown in FIG. 8b, when the focus of the target area 12 is below the level of the solar panel 2, the surface of the solar panel 2 should rather be curved in a concave shape in order for the redirected solar rays to hit the solar panel 2 more perpendicularly. In this invention, an adaptable curvature of the solar panel 2 can be combined to the tilting mechanism to optimize the angles at which solar radiation redirected by the concentrating reflector 1 hits the surface of the solar panel 2. This way, as much as possible of redirected solar radiation hits the solar panel 2 with a normal angle.

As previously mentioned, the mechanisms and systems in this invention's structure, such as the variable tilting mechanism in the connecting bar 7, the motorized system of belts and pulleys in the lateral arm 5, the rotation of the lateral arm 5 around the vertical arm 4, the rotation of the solar panel 2 around the connecting bar 7, and the adaptable curvature of the solar panel 2, can be mechanically or electronically activated by a digital control system. The digital control system is connected to actuators or sensors, for instance, optical sensors (not shown). This system can be located at various locations, including behind the solar panel 2, near the motor that controls the system of belts and pulleys inside the lateral arm 5, or even remotely. By relying on the calculations used in the first place to determine the optimal shapes and positions of the reflecting surfaces 3, on sun track data, on feedback data collected by the optical sensors, and on additional calculations, the digital control system assesses the position, tilt and curvature of the solar panel 2 that are optimal for energy output or conversion. The various systems of the structure can then be mechanically or electronically activated or adjusted by the digital control system to produce this optimal energy output or conversion. These assessment and adjustment processes are repeated continuously.

For example, the optical sensors can provide current output data to the digital control system. Based on this feedback data, the digital control system then estimates output predictions for marginal, or more substantial, changes in the position and variable tilt and curvature of the solar panel 2. If those calculations predict that adjusting one or several of the position, variable tilt or variable curvature of the solar panel 2 can yield a higher energy output, the digital control system adjusts whichever mechanism or system that must be adjusted to produce this higher output. Afterwards, the optical sensors provide updated output data to the digital control system, and further estimations can be calculated.

In another embodiment, when multiple solar concentrators are located in a same area, a single digital control system can operate multiple solar concentrators. This way, feedback data for multiple solar panels is provided to the digital control system. With this additional information, more accurate and efficient output predictions can be made regarding the optimal position, tilt and curvature of each of the solar panels operated by the digital control system.

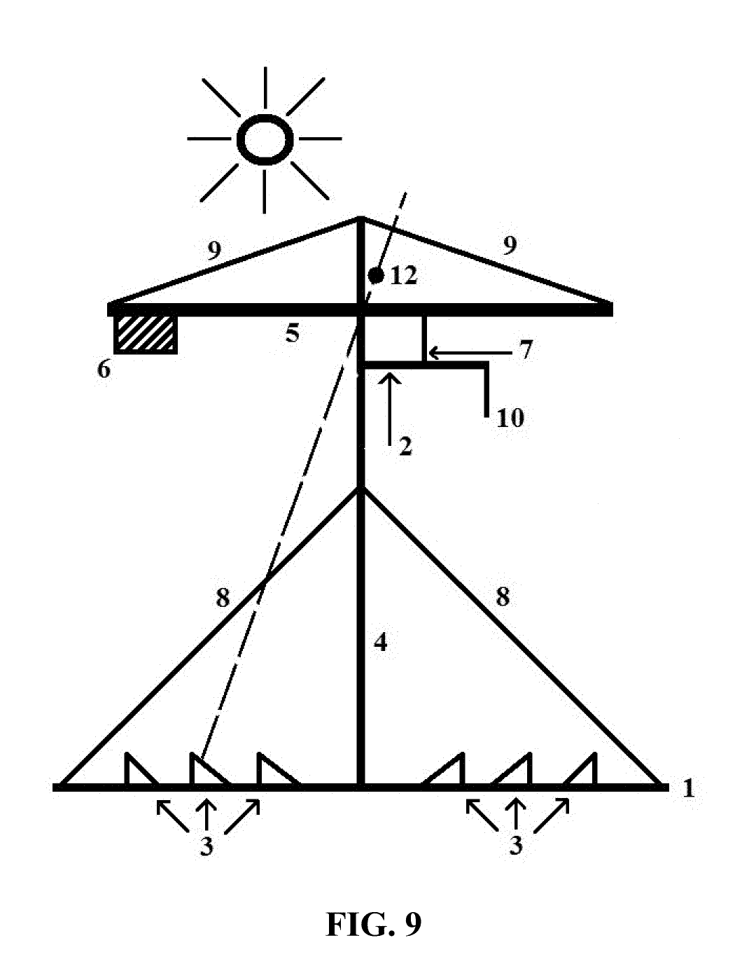

When, in the exemplary embodiment, the position of the sun in the sky entails that the target area of solar radiation redirected from the concentrating reflector 1 is located near the vertical arm 4, regardless of the height of the target area, this invention's structure requires that the solar panel 2 be moved close to the vertical arm 4 to collect this solar radiation. As mentioned above, the system of belts and pulleys inside the lateral arm 5 can move the connecting bar 7 (or whichever apparatus or fastener that links the solar panel 2 to the lateral arm 5) up to the middle of the lateral arm 5. However, a regular solar panel 2 would physically hit the vertical arm 4 and block against it, thereby preventing the connecting bar 7 from reaching the middle of the lateral arm 5. This issue, illustrated in FIG. 9, implies that the solar panel 2 could not adequately receive solar radiation when the target area 12 toward which it is redirected is close to the vertical arm 4. Four inventive solutions are disclosed herein to solve this problem.

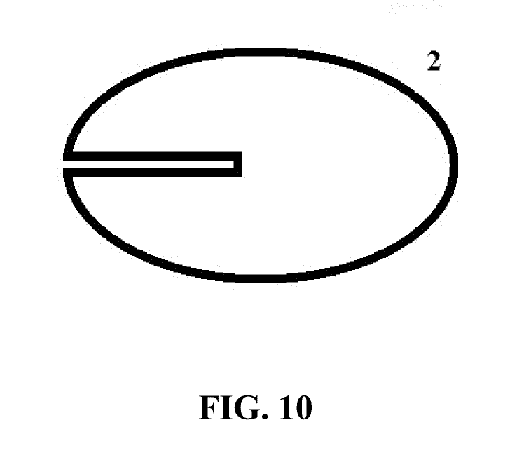

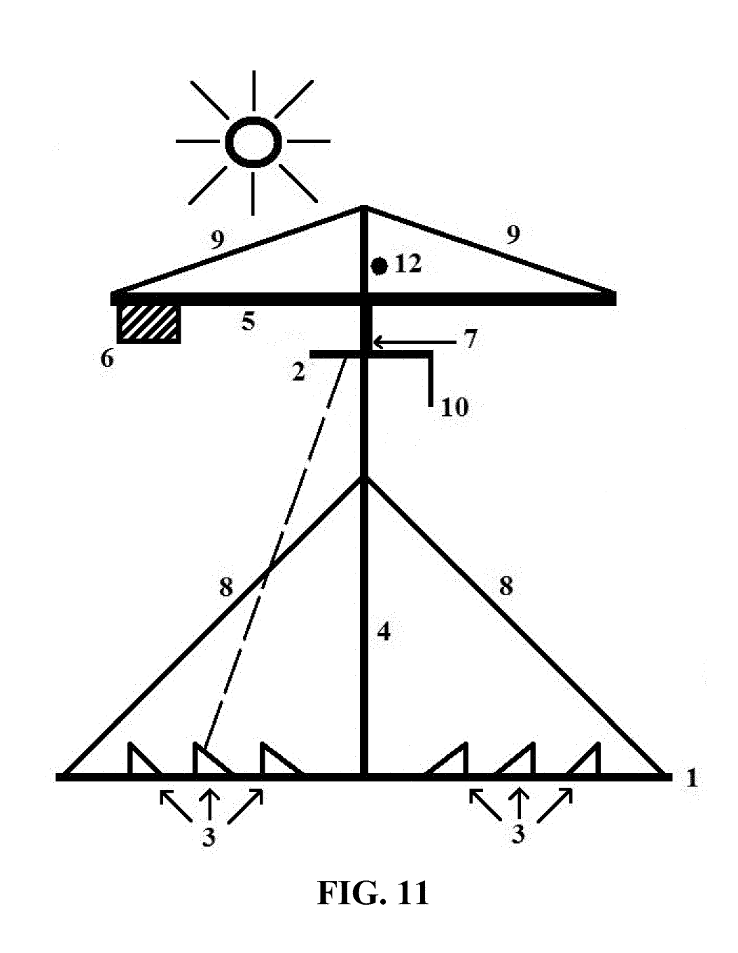

The exemplary embodiment of this invention implements the technically simpler of these four solutions. In this embodiment, illustrated in FIG. 10, a slot is cut in the solar panel 2 so that the solar panel 2 slides around the exterior surface of the vertical arm 4 should the solar panel 2 be moved near the vertical arm 4 to receive solar radiation. The width of the slot is at least equal to the width or diameter of the vertical arm 4. FIG. 11 shows the resulting move of the solar panel 2 toward the middle of the lateral arm 5 when the target area 12 is close to the vertical arm 4. The slot cut in the solar panel 2 allows it to slide around the vertical arm 4. This exemplary embodiment features a disadvantage over its three alternate embodiments, though: when the target area is not located close to the vertical arm 4 (regardless of height), the solar radiation that is redirected from the concentrating reflector 1 and whose trajectory passes through the slot of the solar panel 2 is not received and collected by the solar panel 2, resulting in a loss of efficiency.

### First Alternate Embodiment—Division of the Vertical Arm into Branches

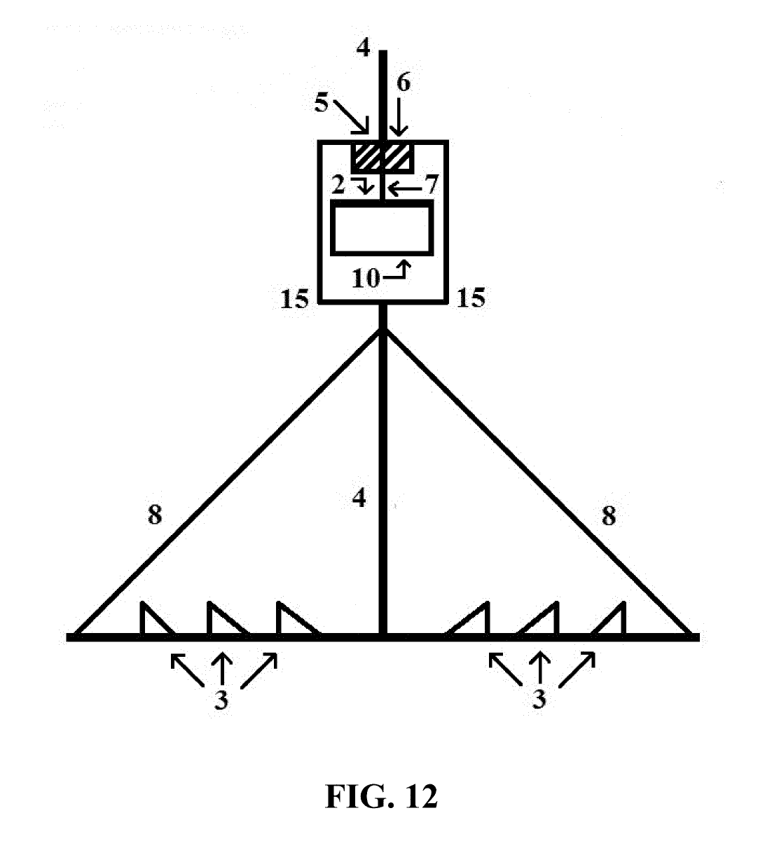

In a first alternate embodiment, best illustrated with a side perspective as shown in FIG. 12, no slot is cut in the solar panel 2. Instead, a portion of the vertical arm 4 is divided into two side branches 15 forming a squared jaw—a person skilled in the art would recognize that the side branches 15 can form a different shape without affecting their functionalities in this invention. Because the solar panel 2 passes inside the gap formed by the two side branches 15, it can be moved as normal up to the middle of the lateral arm 5. This alternate embodiment is potentially more efficient than the principal embodiment.

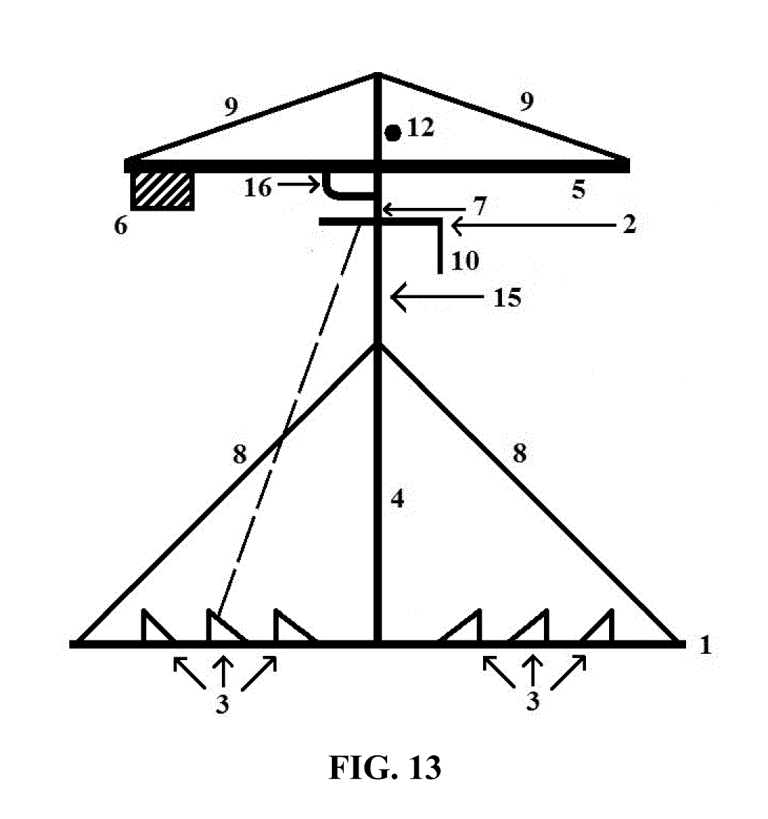

From the bottom up, the division of the vertical arm 4 into two side branches 15 begins somewhere above the junction of the lower support cables 8 with the vertical arm 4. The side branches 15 are then preferably reunified with the vertical arm 4 at the junction of the lateral arm 5 with the vertical arm 4, although this reunification could structurally take place at any place on the vertical arm 4 that is higher than the lateral arm 5 without affecting this invention's basic operations. The gap formed by the side branches 15 must be wide enough and high enough to allow the unobstructed passage of the solar panel 2, taking into account that the preferably oval-shaped solar panel 2 can be tilted, that its curvature is adjustable, that it is attached to the connecting bar 7 (or whichever apparatus or fastener that links the solar panel 2 to the lateral arm 5), and that a mirror reflector 10 can be fastened to it. To compensate for the loss of stability that can arise with the partial division of the vertical arm 4 into two side branches 15, connectors 16 (as seen in the frontal view of FIG. 13) can be integrated to the structure, attaching each of the branches 15 to the lateral arm 5. With this first alternate embodiment, as shown in FIG. 13, the solar panel 2 can move up to the middle of the lateral arm 5 to receive solar radiation redirected by the concentrating reflector 1 when the target area 12 is close to the vertical arm 4. Since no slot is cut in the solar panel 2, this first alternate embodiment is potentially more efficient than the solution described in the exemplary embodiment because it does not reduce the surface area of the solar panel 2. The side branches 15 can be small enough in width to not significantly shield the solar panel 2 from the solar radiation redirected by the concentrating reflector 1 should they be in the trajectory of redirected solar rays, and the connectors 16 can be small enough in width to not significantly block solar rays incoming from the sun.

### Second Alternate Embodiment—Side Structure

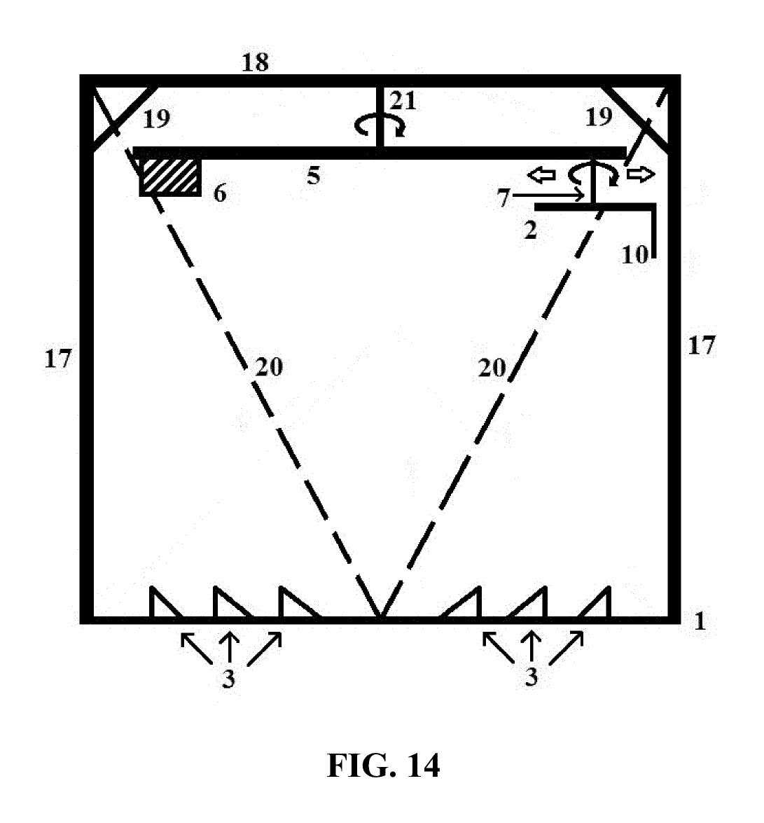

In a second alternate embodiment, illustrated in FIGS. 14 & 15, there is, here as well, no slot cut in the solar panel 2. To allow the solar panel 2 to be moved up to the middle of the lateral arm 5, the principal embodiment's vertical arm 4 is replaced by a different structure, mainly constituted of at least two vertical side beams 17 and one horizontal top beam 18. When there are only two, the side beams 17 are preferably erected at two opposite corners of the stationary plane of the concentrating reflector 1. The two side beams 17 support both ends of the top beam 18, which passes through, or close to, the center vertical axis of the concentrating reflector 1. To strengthen the structure, a crosspiece 19 can connect each of the side beams 17 to the top beam 18. To ensure the overall stability of the structure, two support cables 20 can connect each end of the top beam 18 to the adjacent corners of the concentrating reflector 1. Positioned below the top beam 18, the lateral arm 5 is linked to the middle, or close to the middle, of the top beam 18 by a connecting arm 21 or another apparatus or fastener known in the art, at which connecting point it can rotate (see FIG. 14). As in the principal embodiment of this invention, a solar panel 2, to which a mirror reflector 10 can be fastened, is linked to one side of the lateral arm 5 through a connecting bar 7 or another appropriate apparatus or fastener, while a counterweight 6 is placed on the other side of the lateral arm 5. A person skilled in the art would recognize that, so long as the top beam 18 passes through, or close to, the center vertical axis of the concentrating reflector 1, the side beams 17 can be positioned at various other locations of the perimeter of the concentrating reflector 1 without negatively affecting the structure's energetic performance.

As in the principal embodiment, a motorized system of belts and pulleys inside the lateral arm 5 moves the connecting bar 7 (or whichever apparatus or fastener that links the solar panel 2 to the lateral arm 5) along the lateral arm 5. As there are no obstructing components in this embodiment, the solar panel 2 can be moved up to the middle of the lateral arm 5 to receive solar radiation redirected by the concentrating reflector 1. Since no slot is cut in the solar panel 2, this alternate embodiment is potentially more efficient than the solution described in the principal embodiment because it does not reduce the surface area of the solar panel 2. Since there are no components in this embodiment that can block solar radiation redirected from the concentrating reflector 1 toward the solar panel 2, the present alternate embodiment is potentially more efficient than the first alternate embodiment comprising a vertical arm 4 and side branches 15.

### Third Alternate Embodiment—Prism Structure

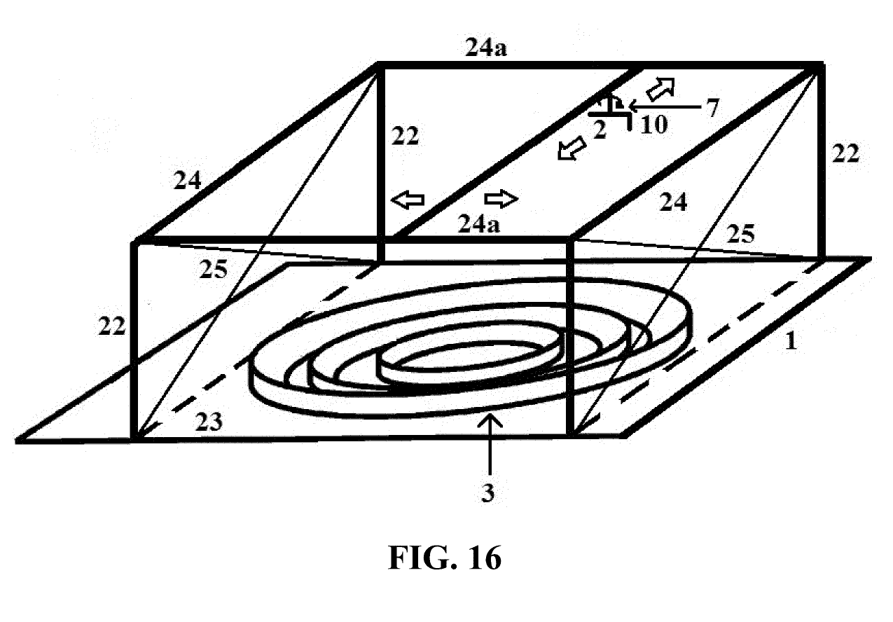

In a third alternate embodiment, illustrated in FIG. 16, there is, here as well, no slot cut in the solar panel 2. Instead, a prism structure is erected on the stationary plane of the concentrating reflector 1. The prism structure is constituted of at least four vertical prism beams 22 that together delineate a rectangular or square area 23 of the concentrating reflector 1. This rectangular or square area 23 preferably comprises the reflecting surfaces 3. Equal in number to the vertical prism beams 22, lateral prism beams 24, 24a connect the vertical prism beams 22 together, preferably at their top ends, in a pattern that follows the borders of the rectangular or square area 23.

In the basic embodiment illustrated in FIG. 16, a lateral arm 5 is connected to any two lateral prism beams 24a facing each other. The structure can also include a lower number of lateral prism beams 24, 24a so long as the lateral arm 5 can be attached to two facing lateral prism beams 24a. The lateral arm 5 can be linearly straight, or it can be slightly curved upward or downward. To strengthen and stabilize the structure and the lateral arm 5, diagonal support cables 25 can be added to the structure. In one example of diagonal support cables 25 illustrated in FIG. 16, wherein the diagonal support cables 25 are installed crossing each other in pairs, the diagonal support cables 25 attach the top ends of each of the vertical prism beams 22 to the bottom ends of at least one adjacent vertical prism beam 22.

As in the other embodiments, the lateral arm 5 supports a solar panel 2 that can be attached to the lateral arm in various ways, for instance, a connecting bar 7. Also, a mirror reflector 10 can be fastened against the solar panel 2, with the same functions and characteristics as in the exemplary embodiment. The solar panel 2 is installed in a way that allows its rotation around the connecting bar 7 (or whichever apparatus or fastener that links the solar panel 2 to the lateral arm 5). Unlike in the exemplary embodiment, the lateral arm 5 does not rotate.

A motorized system inside the lateral arm 5 allows the connecting bar 7 (or whichever apparatus or fastener that links the solar panel 2 to the lateral arm 5) to move along the lateral arm 5. Unlike in the exemplary embodiment, these movements can take place through the entire length of the lateral arm 5. The solar panel 2 moves along with the connecting bar 7 (or whichever apparatus or fastener that links the solar panel 2 to the lateral arm 5). In addition, a motorized system inside the two lateral prism beams 24a that support the lateral arm 5 allows the lateral arm 5 to be moved along the entire lengths of the two lateral prism beams 24a to which the lateral arm 5 is connected. With the rotation of the solar panel 2, the movement of the solar panel 2 along the lateral arm 5, and the movement of the lateral arm 5 along the two lateral prism beams 24a to which the lateral arm 5 is connected, the structure is capable of moving the solar panel 2 anywhere in the rectangular or square area 23. This way, the solar panel 2 can be moved two-dimensionally so that it is continually positioned at or near the target area of concentrated solar radiation redirected by the concentrating reflector 1.

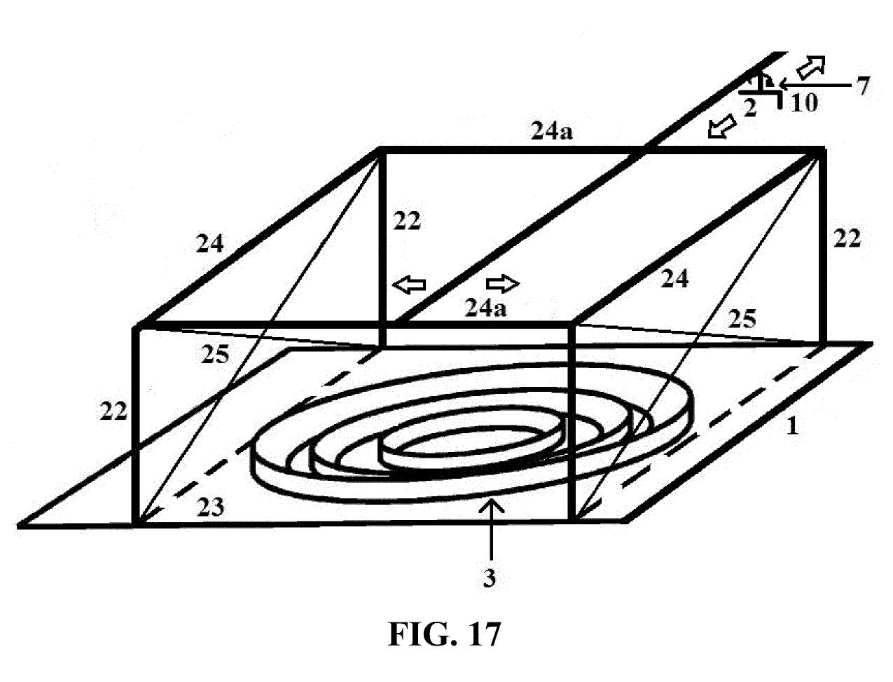

In a similar embodiment illustrated in FIG. 17, the lateral arm 5 is longer than the distance separating the two facing lateral prism beams 24a to which the lateral arm 5 is connected. The lateral arm 5 can extend beyond one or both of the two facing lateral prism beams 24a. In another embodiment, the lateral arm 5 can be adjustably extended farther than the two facing lateral prism beams 24a to which the lateral arm 5 is connected. These alternate embodiments allow the solar panel 2 to be positioned outside of the rectangular or square area 23 to receive redirected solar radiation.

As in the exemplary embodiment, the motorized systems can be systems of belts and pulleys, and they can be mechanically or electronically activated by a digital control system. Since no slot is cut in the solar panel 2, this alternate embodiment is potentially more efficient than the solution described in the exemplary embodiment because it does not reduce the surface area of the solar panel 2. Since there are no components in this embodiment that can block solar radiation redirected from the concentrating reflector 1 toward the solar panel 2, the present alternate embodiment is potentially more efficient than the first alternate embodiment comprising a vertical arm 4 and side branches 15. As another benefit over the exemplary embodiment and the other alternate embodiments, the present embodiment does not require any counterweight 6.

Two more applications can complement the present invention to increase its efficiency. Although the following embodiments can separately or together be incorporated in the exemplary embodiment of the present invention as well as in all three of the alternate embodiments, they are herein described and drawn only in combination with the exemplary embodiment of the present invention, in which a slot is cut in the solar panel 2. Their respective implementations to the three alternate embodiments of this invention do not require substantial or technically challenging adaptations in comparison with their implementation in the exemplary embodiment of the present invention.

### Additional Embodiment—Collection of Unabsorbed Light

Most types of solar panels are not able to collect and convert into electricity all of the infrared light incoming from the sun or redirected by reflectors. Instead, substantial parts of solar radiation whose wavelengths are associated with infrared light are typically wasted as they turn into mere heat upon hitting a solar panel. The present embodiment discloses means for efficiently collecting and using this heat in this invention's solar energy concentrator.

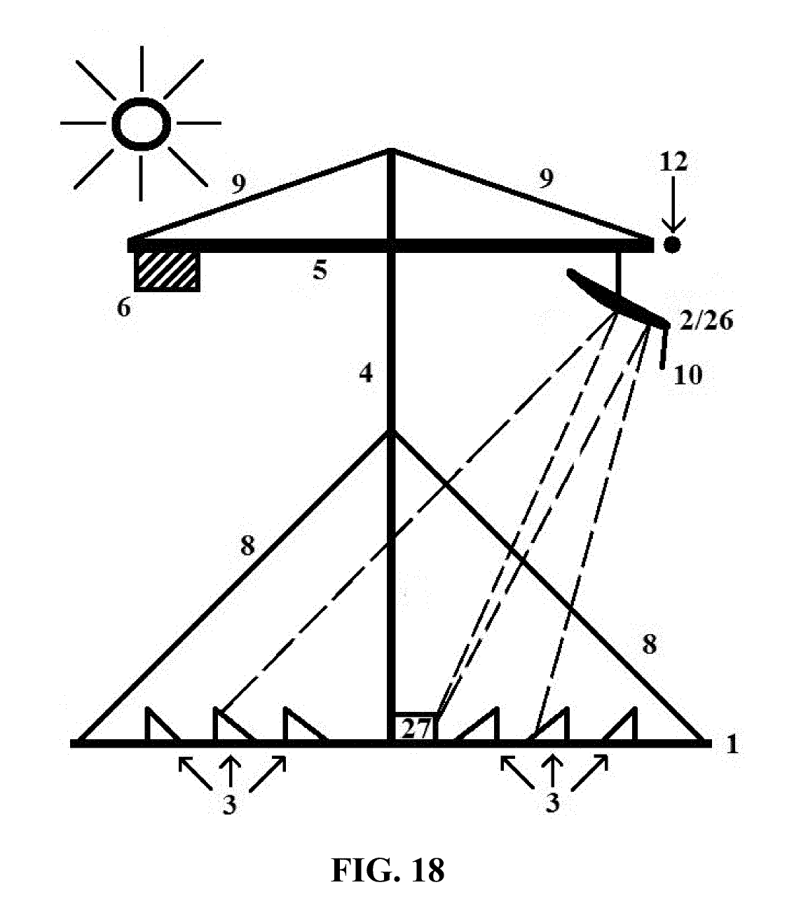

In the present embodiment graphically represented in FIG. 18, a filter 26, such as an optical filter, is positioned under the solar panel 2 or covers the solar panel 2. The filter 26 does not prevent the passage of parts of solar radiation that can be absorbed by the solar panel 2, yet reflects parts of solar radiation that would not be absorbed by the solar panel 2. For instance, if a particular solar panel 2 does not absorb any infrared light, the filter 26 would allow the passage of parts of solar radiation whose wavelengths are associated with visible and ultraviolet light, yet would reflect parts of solar radiation whose wavelengths are associated with infrared light. Relying on the fixed or variable tilting mechanism of the solar panel 2, on the curvature of the solar panel 2, or both, the filter 26 reflects this unabsorbed solar radiation toward a central heat absorber 27 positioned on the plane surface of the concentrating reflector 1, preferably at its center, close to or against the vertical arm 4. The central heat absorber 27 in turn collects the heat of the solar radiation diverted upon it, thereby increasing its temperature. For instance, this heat could be used to generate electricity, or it could directly be transferred to a useful purpose heating water, heating the building on which the structure is installed, etc. The central heat absorber 27 uses this heat as a source of energy. In order to include this energy output in the invention's output estimations, feedback data from the central heat absorber 27 can be transmitted to the digital control system, which can take this data into account in its assessments of energy output and adjustments of the invention's various mechanisms.

FIG. 18 illustrates a specific redirection of unabsorbed solar rays in which a variable tilting mechanism as described above is mainly adapted to redirect the reflected yet unabsorbed solar radiation toward the central heat absorber 27. In this example, the parts of solar radiation that can be absorbed by the solar panel 2 complete their course at the solar panel 2, where they are collected. The adaptable curvature of the solar panel 2 still allows these solar rays redirected by the concentrating reflector 1 to hit the solar panel 2 more perpendicularly than with a default, flat solar panel. However, for various locations of the target area, a trade-off might be necessary between the efficiency benefits of redirecting more solar radiation toward the central heat absorber 27 and the efficiency benefits of having solar radiation that can be absorbed by the solar panel 2 hit the solar panel 2 at relatively more perpendicular angles. These trade-offs would determine the optimal tilt and curvature of the solar panel 2 for these specific locations of the target area. Feedback information provided from the central heat absorber 27 to the digital control system helps the digital control system in determining this optimal trade-off and in adjusting the various mechanisms of the present invention accordingly.

### Additional Embodiment—Heat Transfer

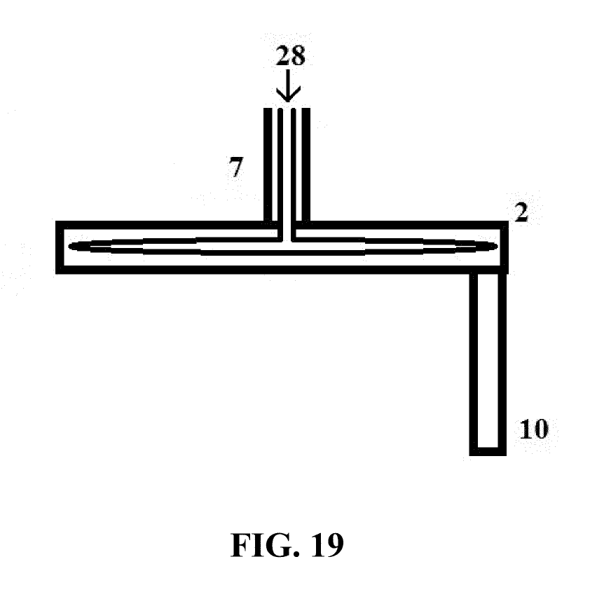

Solar radiation impinging on the solar panel 2 increases its temperature, and excessive heat needs to be removed from the solar panel 2 in order to prevent structural damage to the solar panel 2. The present embodiment discloses a particular method to efficiently achieve this removal of excessive heat from the solar panel 2 in the context of this invention's structure: a heat pipe. Henceforth is disclosed one embodiment of a heat transfer fluid pipe in this invention's solar energy concentrator, illustrated in FIG. 19. During the manufacture of the components of the solar energy concentrator, a heat pipe 28 is installed inside the solar panel 2. When the solar panel 2 is assembled with the present invention's other components, this heat pipe 28 extends inside the connecting bar 7 (or whichever apparatus or fastener that links the solar panel 2 to the lateral arm 5). The heat pipe 28 can be designed so that it is lengthened or extended into further components of the present invention, such as the lateral arm 5, the mechanical structure that supports the lateral arm 5, or into the concentrating reflector 1. This heat pipe 28 contains a suitable working fluid, the particular nature of its suitability being that it lies in a liquid phase under normal ambient temperatures, while the temperatures activating its phase transition to a vaporous form match the range temperatures of the solar panel 2 during operation of this invention. Moreover, the constituting material of the heat pipe 28 is specifically selected so that it interacts adequately with the selected working fluid, both in thermal conductivity and in contact reactions—for example, absence of corrosion.

When heat is gathered at the surface of the solar panel 2, the materials of the solar panel 2 conduct it toward the section of the heat pipe 28 that is encased in the solar panel 2, and the temperature of the working fluid in that limited section of the heat pipe increases. As heat is accumulated therein, the working fluid then in a liquid phase eventually transforms into vapor, its volume thus expanding. This expansion causes pressure into the heat pipe 28, whereby the hotter working fluid now in a vaporous phase is pulled out of the section of the heat pipe 28 that is encased in the solar panel 2, toward the section of the heat pipe 28 that is inside the connecting bar 7 (or whichever apparatus or fastener that links the solar panel 2 to the lateral arm 5). This vapor potentially expands into further sections of the heat pipe 28 that extend inside the other components of the present invention, such as the lateral arm 5, the mechanical structure that supports the lateral arm 5, or into the concentrating reflector 1. In the sections of the heat pipe 28 that are not encased in the solar panel 2, the heat of the vaporous working fluid is conducted to the colder solid materials that constitute these components. Since the structure and the concentrating reflector 1 are relatively large and typically made of metal, they have a great capacity to expel heat. The consequent temperature drop in those sections of the heat pipe 28 causes the working fluid to transform back into a liquid phase, and the resulting working fluid in a liquid phase is drawn back to the section of the heat pipe 28 that is encased in the solar panel 2. With these thermal reactions, which reoccur in continual loops, excessive heat keeps circulating from the solar panel 2 to the other components of this invention, to which the solar panel 2 is connected directly or indirectly through the heat pipe 28.

As an alternative to the heat pipe 28, the solar panel 2 can comprise a heat sink component, such as a layer of a metallic material with excellent thermal conductivity. This layer is physically in touch, directly or indirectly, with the present invention's other components, such as the connecting bar 7 (or whichever apparatus or fastener that links the solar panel 2 to the lateral arm 5), the lateral arm 5, the mechanical structure that supports the lateral arm 5, or the concentrating reflector 1. With this heat sink, heat is conducted from the solar panel 2 to the other components of the present invention. Since the structure and the concentrating reflector 1 are relatively large and typically made of metal, they have a great capacity to expel heat.

The present embodiment allows the invention to dispense with external and potentially wasteful or cumbersome means to remove excessive heat at the solar panel 2. In addition, when this invention is installed at a location that faces cold or snowy climate conditions, this integrated transfer of heat from the solar panel 2 to the concentrating reflector 1 or to the structure as a whole efficiently reduces the need for costly climate-related upkeep operations such as heating or snow removal.

The present invention offers several particular advantages. Being a small-scale, dimensionally-adaptable solar concentrator system featuring high energy conversion efficiency, it requires low building and operation costs. Moreover, except for the third alternate embodiment with the prism structure, the configurations of the other embodiments of the present invention provide a particular advantage: in those embodiments, all moving components are located in the lateral arm 5 or in the connecting bar 7 (or whichever apparatus or fastener that links the solar panel 2 to the lateral arm 5). These configurations allow for an easy and simple replacement of the system's moving components or of the solar panel 2 without having to change, replace or manipulate any stationary component. Those stationary components, such as the concentrating reflector 1 or the mechanical structure, tend to be very durable. In the context of locally-distributed solar energy concentrators as in the present invention, this feature allows repairs to be made or technology upgrades—for instance, more efficient solar panels—to be implemented without having to make any change or adjustment in those stationary components. Considering the fast improvement rate in the technological development of PV solar panels and the particular importance of a solar panel's conversion ratio when used in a concentrating system, significant performance benefits can stem from being able to upgrade the system easily.

While this invention has been particularly shown and described with reference to an exemplary embodiment and alternate and additional embodiments, it will be understood by those skilled in the art that various changes in form and detail may be made therein without departing from the spirit and scope of the invention. The invention in its broadest, and more specific aspects, is further described and defined in the claims which now follow

I claim:

1. A solar energy concentrator system comprising:
a concentrating reflector comprising a plurality of facets, each of the facets having a reflective layer and arranged on a support surface exposed to sunlight to form a plurality of reflecting surfaces, wherein the reflecting surfaces remain motionless during operation and are oriented to converge sunlight on a common target area, and wherein the common target area moves with a change in an apparent position of the sun;
a solar panel to receive the converged sunlight;
a supporting structure connected to the support surface, and
a repositioning mechanism connected at a connecting point to the supporting structure to maintain the solar panel positioned either at or near the common target area, wherein the repositioning mechanism comprises a lateral arm that is rotatable about the connecting point, and wherein the solar panel is connected to a first side of the lateral arm and is movable along the first side of the lateral arm.

2. The solar energy concentrator system as claimed in claim 1 wherein the solar panel is oval in shape.

3. The solar energy concentrator system as claimed in claim 1 wherein the solar panel has a concave curvature.

4. The solar energy concentrator system as claimed in claim 1 wherein the solar panel has a convex curvature.

5. The solar energy concentrator system as claimed in claim 1 wherein the solar panel has an adjustable curvature.

6. The solar energy concentrator system as claimed in claim 5 wherein the curvature of the solar panel is adjusted for the solar panel to receive a larger share of the converged sunlight at an angle that is more perpendicular to the solar panel.

7. The solar energy concentrator system as claimed in claim 1 wherein the solar panel is tilted.

8. The solar energy concentrator system as claimed in claim 1 wherein the solar panel is tiltable.

9. The solar energy concentrator system as claimed in claim 1 wherein the solar panel is adjustably tilted for the solar panel to receive a larger share of the converged sunlight at an angle that is more perpendicular to the solar panel.

10. The solar energy concentrator system as claimed in claim 1 wherein the solar panel is rotatable.

11. The solar energy concentrator system as claimed in claim 1 wherein the lateral arm is curved for the solar panel to receive a larger share of the converged sunlight at an angle that is more perpendicular to the solar panel.

12. The solar energy concentrator system as claimed in claim 1 wherein the solar panel is movable along the lateral arm at least up to the connecting point.

13. The solar energy concentrator system as claimed in claim 1 wherein the supporting structure comprises a vertical arm positioned in a center portion of the support surface.

14. The solar energy concentrator system as claimed in claim 13 wherein:
the solar panel is movable along the lateral arm at least up to the connecting point, and
the solar panel comprises a slot for the solar panel to slide around the vertical arm when the solar panel is moved up to the connecting point.

15. The solar energy concentrator system as claimed in claim 1 wherein the supporting structure comprises:
a lower vertical arm positioned in a center portion of the support surface;
an upper vertical arm connected to the lateral arm at the connecting point, and
at least two side arms connecting the lower vertical arm to the upper vertical arm, wherein the at least two side arms form a gap.

16. The solar energy concentrator system as claimed in claim 15 wherein the solar panel is movable along the lateral arm at least up to the connecting point, and a part of the solar panel passes through the gap when the solar panel is moved up to the connecting point.

17. The solar energy concentrator system as claimed in claim 1 wherein the supporting structure comprises at least two vertical arms connected to a horizontal arm positioned above the lateral arm, wherein the horizontal arm is connected to the lateral arm at the connecting point.

18. The solar energy concentrator system as claimed in claim 1 wherein a filter at the solar panel reflects at least some wavelengths of the converged sunlight that are unabsorbed by the solar panel toward an absorber.

19. The solar energy concentrator system as claimed in claim 18 wherein the at least some wavelengths of the converged sunlight that are unabsorbed are infrared.

20. The solar energy concentrator system as claimed in claim 18 wherein the solar panel is adjustably tilted for the filter to reflect the at least some wavelengths of the converged sunlight that are unabsorbed by the solar panel toward the absorber.

21. The solar energy concentrator system as claimed in claim 18 wherein the solar panel has an adjustable curvature for the filter to reflect the at least some wavelengths of the converged sunlight that are unabsorbed by the solar panel toward the absorber.

22. The solar energy concentrator system as claimed in claim 1 wherein the solar panel has a heat transfer fluid pipe extending into the repositioning mechanism.

23. The solar energy concentrator system as claimed in claim 22 wherein the heat transfer fluid pipe contains a working fluid that transforms from a liquid to a vaporous phase when the working fluid is contained in a portion of the heat transfer fluid pipe that receives the converged sunlight.

24. A solar energy concentrator system comprising:
a concentrating reflector comprising a plurality of facets, each of the facets having a reflective layer and arranged on a support surface exposed to sunlight to form a plurality of reflecting surfaces, wherein the reflecting surfaces remain motionless during operation and are oriented to converge sunlight on a common target area, and wherein the common target area moves with a change in an apparent position of the sun;
a solar panel to receive the converged sunlight;
a supporting structure connected to the support surface, wherein the supporting structure comprises at least two horizontal arms, and
a repositioning mechanism to maintain the solar panel positioned either at or near the common target area, wherein the repositioning mechanism comprises a lateral arm that is connected to at least two horizontal arms of the supporting structure and is movable along said at least two horizontal arms, and wherein the solar panel is connected to the lateral arm and is movable along the lateral arm.

25. The solar energy concentrator system as claimed in claim 24 wherein at least one segment of the lateral arm extends further than at least one of the at least two horizontal arms to which the lateral arm is connected.

26. The solar energy concentrator system as claimed in claim 25 wherein the solar panel is movable along said at least one segment.
